(19) United States
(12) Patent Application Publication
(10) Pub. No.: US 2009/0276979 A1
(43) Pub. Date: Nov. 12, 2009

(54) Tool saver hand tool systematic tethering safety device

(75) Inventors: William W. Kauffman, Doylestown, PA (US); Jessica J. Pittaway, Doylestown, PA (US)

Correspondence Address: Kauffman/Pittaway, 403 South Main Street, Unit S-100, Doylestown, PA, 18901, US

(73) Assignees: William Weiger Kauffman, Doylestown, PA (US); Jessica Jane Pittaway, Doylestown, PA (US)

(21) Appl. No.: 12/380,815

(22) Filed: Mar. 4, 2009

Related U.S. Application Data
(60) Provisional application No. 61/071,618, filed on May 8, 2008.

(51) Int. Cl. A44B 21/00; A45F 3/14; F16G 15/08

(52) U.S. Cl. 24/3.13; 224/221; 24/583.1

(57) ABSTRACT

The tool saver hand tool systematic tethering safety device is intended for use with hand tools (which could be defined as tools intended to be used by an operators hands, by way of the hand tools' handle, or grip). Hand tools are well known to drop accidentally out of an operators' hands, and the tool saver hand tool systematic tethering safety device will stop said hand tool from falling completely away from said operator, through the use of the systems' hand tool receiving apparatus, having been fit securely onto any hand tool, being then attached, through the use of its center linkage assembly, to a wrist piece, which, then, said wrist piece, fits comfortably, and securely onto an operators wrist.

### CROSS-REFERENCE TO RELATED APPLICATIONS

U.S. Utility Provisional Patent No. 61/071,618 filed May 8, 2008

### STATEMENT REGARDING FEDERALLY SPONSORED RESEARCH OR DEVELOPMENT

Not applicable

### REFERENCE TO SEQUENCE LISTING, TABLE, OR COMPUTER PROGRAM LISTING CD AP.

Not Applicable

### BACKGROUND INFORMATION

This invention relates to any hand tool that might be used by professionals, and or, amateurs alike, within any industry, or in any application, in which a hand tool would be used. A hand tool might be categorized as a tool intended to be used by an operators' hands, with a handle, or grip, integrated within the hand tools' design.

A common problem with hand tools, of any kind, is when said hand tool is accidentally dropped from, and falls completely away from, the said operators' hands, resulting in damage, or loss, occurring to said hand tool, and other equipment, as well as, when this occurs, a hand tool becomes a safety hazard, resulting in injury to oneself, or others.

### BACKGROUND OF THE INVENTION CONT.

Therefore there is a need, for many people, to be able to attach a hand tool to their wrists before performing any function with that said hand tool, through an easily attachable, universal, hand tool systematic tethering safety device. By allowing any operator the opportunity to attach any hand tool to their wrist, one will be eliminating the damage done too, or the loss of, hand tools, and other equipment, as well as, reducing the safety hazards created by the dropping, or slippage, or loss of a hand tool during its use.

### BRIEF SUMMARY OF THE INVENTION

In view of the foregoing background, the object of the present invention, is to provide a universal systematic tethering safety device, that will be easy for any operator to install onto any, or all, hand tools known, or manufactured, that might be used during the performance of any function with said hand tools. In turn, once the hand tool is so attached, prevention of the hand tool from falling completely away from the operator when dropped, will be achieved. With the present invention, the above needs, as described in the background, will be met.

Specifically, the present invention comprises of three parts within its design. The basic design of the present invention consists of: (1) An easy to install receiving apparatus to be attached to the handle, or grip, of any hand tool. (2) A center linkage assembly, usually, but not always, detachable from the hand tool receiving apparatus end, and or, the wrist piece end. (3) A wrist piece band, coil, et cetera., intended to be attached to an operators wrist.

The tool saver hand tool systematic tethering safety device is designed to universally fit around the handle, or grip, of any hand tool, being able to chinch down firmly, or otherwise attach onto, any type of material the handle is constructed of, and any size, or type, of handle, as well. The tool saver hand tool systematic tethering safety device is designed to attach easily, and detach easily, on, and off, of the operators wrist. Once this invention is properly installed, resulting in attaching, or tethering, the hand tool to the operators wrist, the said hand tool will be stopped from falling completely away from the said operator, when the hand tool is dropped, or lost, from the operators' hands.

### BRIEF DESCRIPTION OF THE SEVERAL VIEWS OF THE DRAWINGS

FIG. 1 is a perspective view of a possible construction of the wrist piece.

FIG. 2 is a perspective view of a possible construction of the center linkage assembly.

FIG. 3 is a perspective view of a possible construction of the hand tool receiving apparatus.

FIG. 4 is a perspective view of the fully constructed hand tool tethering safety device, consisting, in whole, of the three basic design parts of the system that is the present invention:

FIG. 4a being the attachment point of the wrist piece to the center linkage assembly.

FIG. 4b being the attachment point of the center linkage assembly to the hand tool receiving apparatus.

FIG. 5 is a perspective view of an example of a hand tool, operating in its functional use, as it would be attached to the operators wrist. This universal hand tool systematic tethering safety device will cushion, and stop, the hand tool from falling completely away from the operator, when the tool is dropped, or lost, from the operators' hands.

### DETAILED DESCRIPTION OF THE INVENTION

The present invention will now be described in more detail, using references to the accompanying drawings, in which the preferred embodiment of this invention will be shown.

Do not limit the scope of this invention by this particular embodiment, as set forth herein, being that a multitude of hand tool styles, and designs, will need to be considered, and constructed for, and only minor material, and design, changes will be necessary, and justified, in the future, in order to produce, and market, this invention for different categories, and types, of hand tools.

This embodiment is being provided in order for this application to be thorough, and complete, and so as to fully convey the true scope of this invention to those skilled in the arts to which this invention pertains.

The wrist piece, as shown in FIG. 1, is a comfortable to wear, pre-manufactured part, such as a wrist coil, band, et. cetera, that allows the hand tool operator to easily attach the hand tool saving tethering safety system onto, and off of, said operators wrist. The wrist piece provides the anchor point for the hand tool to be attached to the operator. This does stop said hand tool from falling completely away, when said hand tool happens to be dropped, or lost, from said operators hands, because said hand tool will be attached to said operators wrist, through the use of the tool saver hand tool systematic tethering safety device.

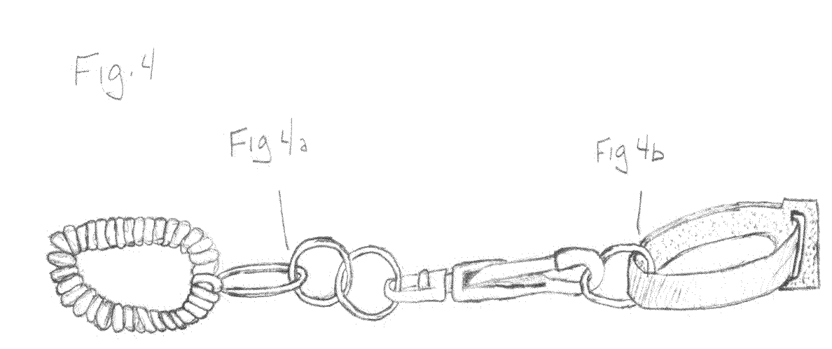

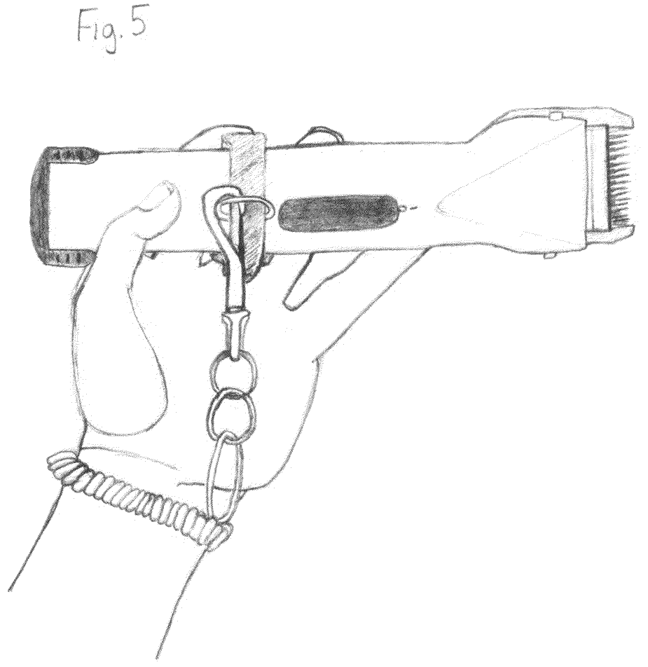

This wrist piece also has an exact anchor point integrated into its own design, such as, for example, a metal ring, that allows the center linkage assembly to be attached to one end of the wrist piece(FIG. 4a).

### DETAILED DESCRIPTION OF THE INVENTION CONT.

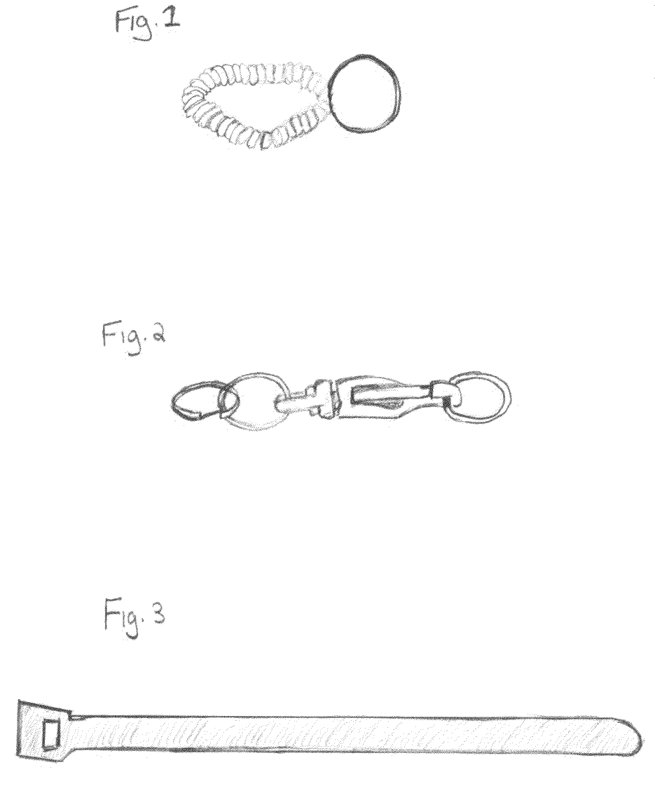

The center linkage assembly, as shown in FIG. 2, is a length constructed of materials, such as, for example, metal chain, metal rings, links, bands, cords, snaps, clasps, hooks, et cetera., and is the tether between, and attaches both, the wrist piece, FIG. 1, and the hand tool receiving apparatus, FIG. 3, to each other. The purpose of the center linkage system is to tether the hand tool, with the receiving apparatus installed, to the operator, who is wearing the wrist piece(see FIG. 5).

The hand tool receiving apparatus, as shown in FIG. 3, is constructed of a pre-manufactured, long, thin strip of material, such as, for example, ‘Velcro’, or ‘Neoprene’, and will be constructed, using any material specifications, small hardware parts, and adhesives, et cetera., necessary in order to allow said receiving apparatus to fit around, or connect to, any hand tools' handle surface. The hand tools' receiving apparatus is attached to an intended, exact, anchor point of the center linkage assembly(FIG. 4b), completing the entire assembly of the tool saver hand tool systematic tethering safety device(FIG. 4), before the entire tool saver hand tool systematic tethering safety device can be installed onto the hand tools' handle surface, and used by the operator of the hand tool.

Once the assembly is constructed, installed onto a hand tool, and then fixed onto an operators wrist, (See FIG. 5), the tool saver hand tool systematic tethering safety device will stop the hand tool from falling completely away from the operator, when dropped, or lost, from the operators' grip.

The invention, as applied for, does meet the needs expressed throughout this application, with the tool saver hand tool systematic tethering safety device as described within this application. In no way is there a limit to material choices, and specifications of materials, used for the construction of this invention, nor is there a limit to small, justified, design changes within the construction process of this invention. This flexibility is necessary in order for each tool saver hand tool systematic tethering safety device that will be constructed, and marketed, to be applicable to each type, and category, of hand tool known, and manufactured.

The invention claimed is:

1. A hand tool systematic tethering safety device intended for use with all known, and, or manufactured hand tools, comprising of: a wrist piece band, coil, et cetera., having means for receiving a connector piece from the center linkage assembly, and said center linkage assembly having the means for receiving the connector piece from the hand tool receiving apparatus.

2. The wrist piece of claim 1 need only be a band, coil, et. cetera, that is able to attach, and detach, to, and from, the hand tool operators' wrist, and does have, integrated into it's own design, the method for being attached to the center linkage assembly.

3. The center linkage assembly of claim 1 is constructed from appropriate materials, and is the tethering piece between the operator's wrist, with the wrist piece installed, and the hand tool in use, with the hand tool receiving apparatus installed, and said center linkage assembly might, or might not, be easily detachable from the wrist piece, and, or, hand tool receiving apparatus, after initial construction.

4. The hand tool receiving apparatus of claim 1, is constructed in a manner so as to wrap, and cinch upon, snap, and or, connect into, or onto, the handle, or grip, of any hand tool, and does have integrated into it's own design, the method for being attached to the center linkage assembly.
